(19) United States
(12) Patent Application Publication
(10) Pub. No.: US 2018/0224157 A1
(43) Pub. Date: Aug. 9, 2018

(54) FLUID SOLAR HEATING SYSTEM

(71) Applicant: Ofer ZVULUN, Kibutz Ramat Yohanan (IL)

(72) Inventor: Ofer ZVULUN, Kibutz Ramat Yohanan (IL)

(21) Appl. No.: 15/506,153

(22) PCT Filed: Aug. 24, 2015
(86) PCT No.: PCT/IL2015/050846

§ 371 Date: Feb. 23, 2017

(30) Foreign Application Priority Data
Aug. 26, 2015 (IL) 234308

(51) Int. Cl. F24S 10/40; F24S 10/75; F24S 25/33; F24S 40/52

(52) U.S. Cl. CPC F24S 10/40; F24S 40/52; F24S 25/33; F24S 10/75

(57) ABSTRACT

A heating system comprising a non-tlai transparent housing comprising walls made of heat isolating material; a tank within the housing for receiving liquid; a platform laid on the ground; legs holding the tank on the platform; light-absorbent and heat conductive fins coupled to the tank, and a cold fluid inlet with a non-return valve therein, and a hot water fluid, the inlet and outlet extending from the tank to outside the housing; means to transfer heated air from inside the housing to outside the housing.

### FIELD OF THE INVENTION

The present invention relates to stationary systems for heating fluid and in particular water by solar radiation for use in residential and industrial buildings, as well as for agriculture and animal husbandry.

### BACKGROUND OF THE INVENTION

Solar energy water heater systems are generally made of at least two major parts: a water tank and solar panels. The tank and panels are as a rule connected to each other by water piping, but besides that connectivity they are separate units. The panels are designed to maximize heating of the water, whereas the tank is designed to maximize conservation of heat in water therein, by being thermally insulated from the air surrounding the tank.

However, the panels and the tank are both not amenable to repair and are difficult and costly to replace. The systems also require a large amount of space for these two bulky components. Furthermore, the commercially available systems are unsuitable for arid areas that have limited supply of fresh water, wherein brackish water is used for purposed other than drinking: the structure of these panels is unsuitable for heating brackish water which can quickly corrode the panels or cause blockages from precipitation. The commercially available systems are also limited in size due to pressure and other constraints, such that they are unsuitable for heating large structures such as greenhouses, and poultry pens, which often require large input of heat in the night or in the cold seasons.

U.S. Pat. No. 4,452,231 describes a system that combines a water tank and a solar collector. Incorporated into the upper face of the tank are ridges alternating with indentations that are intended to make the tank a solar energy collector. At least one such water tank is placed in an insulated container, and insulation covers the underside and side walls of the collector/heater.

US20110030676 describes a similar system, wherein the upper face of he tank is made of hemispherical bodies.

U.S. Pat. No. 4,064,868 teaches a solar heat collector that includes a hollow panel with an insulated backwall connected to a cover plate by insulated spacer side walls. Heat transfer fins are also described.

WO2003/006896 describes a solar thermal collector of greenhouse type for conversion of radiated sunlight into heat of working substance in tanks, a horizontal and a vertical cylinder in which the substance is flowing. The space is surrounded with a reflecting coating.

The present invention is an improved compact and simple system that aims to overcome these shortcomings.

### SUMMARY OF THE INVENTION

According to one aspect, a fluid heating system is provided substantially as described in the appended description and the figures.

According to another aspect, a method of heating fluid substantially as described in the appended description and the figures is provided.

According to one aspect, a fluid heating system is provided comprising:
non-flat transparent housing comprising walls made of heat isolating material;
a fluid tank within the housing;
a platform laid on the ground;
legs holding the tank on the platform;
light-absorbent and heat conductive fins coupled to the tank, and
a cold fluid inlet with a non-return valve therein, and a hot fluid outlet, the inlet and outlet extending from the tank to outside the housing.

According to another aspect, a fluid heating system is provided comprising:
a non-flat transparent housing comprising a top part and a bottom part; wherein the bottom part comprises a first layer of heat isolating material and the top part comprises a second layer of heat isolating material, wherein the second layer is substantially thicker than the first layer;
a fluid tank within the housing;
means to secure the tank in a vertical orientation to a building;
light-absorbent and heat conductive fins coupled to the tank, and
a cold fluid inlet with a non-return valve therein, and a hot fluid outlet, the inlet and outlet extending from the tank to outside the housing.

The fluid heating systems may further comprise means to transfer heated air from inside the housing to outside the housing. Such systems may further comprise a fan directed to blow on the fins.

Some embodiments comprise circlets that comprise the fins. The circlets are in some embodiments snap-ons.

The circlets may each further comprise a band 0.5-1 mm thick that abuts the tank.

Preferably the circlets comprise heat-conductive material.

In some preferred embodiments the housing comprises sheets of polycarbonate.

In some embodiments the housing comprises at least one inner wall and at least one external wall, wherein the external wall is 6-10 mm thick.

Some embodiments further comprise flaps or shutters, wherein the flaps or shutters are coupled to the housing and are configured to open and allow the tank to be heated by solar radiation and to close to allow helping the tank retain heat.

The flaps or shutters may comprise heat-isolating material.

The flaps or shutters have a side facing the tank, and in some embodiments the side facing the tank comprises light-reflective material.

Some embodiments further comprise a hood adjacent to the tank and essentially positioned between the tank and the housing, and rotatable around the tank, the hood configured to allow the tank to be exposed to sunlight, when the housing is exposed to sunlight having an intensity above a predetermined threshold, by rolling around the tank to below the tank, and to help the tank retain heat when, when the housing is exposed to sunlight having an intensity below a predetermined threshold, by rolling around the tank to above the tank.

Some embodiments with a hood further comprise an undercover adjacent to the tank and essentially positioned between the tank and the platform, wherein the undercover comprises heat-isolating material and the hood is closely slidable over or under the undercover.

In some embodiments the walls are gridded.

Some embodiments further comprise:
rollers between the housing and the tank;
heat isolating blankets wound on the rollers;
and motors mechanically coupled to the motors;
wherein the blankets are wound up and unwound on the rollers by the motors according to measured intensity of sunlight on the housing.

### BRIEF DESCRIPTION OF THE FIGURES

Some embodiments of the invention are herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may he embodied in practice. Some elements were omitted in some of the drawings merely to help focus the discussion on particular features.

In the drawings:

FIG. 1 schematically depicts a water heating system embodiment including an housing with contiguous double walls (internal and external) having essentially empty space in-between, and a water tank within the housing, with fins thereon.

FIG. 2 illustrates a circlet with fins similar to the fins shown in FIG. 1.

FIG. 3 schematically depicts another water heating embodiment, that has a housing with shutters.

FIG. 4 shows an external wall and an internal wall of a housing, the walls being interconnected with a supportive grid.

FIG. 5 illustrates another embodiment in which there are external walls that are essentially flaps.

FIG. 6 demonstrates an embodiment having a hemispherical housing, and

FIG. 7 shows another embodiment having a pyramidal housing.

FIG. 8 illustrates yet another embodiment in which there is an isolating hood and undercover covering the water tank.

FIG. 9 shows another embodiment that comprises a roll-up mechanism for rolling a heat-isolation blanket over the water tank.

FIG. 10 schematically illustrates an embodiment installed on a vertical wall of a building.

### DETAILED DESCRIPTION

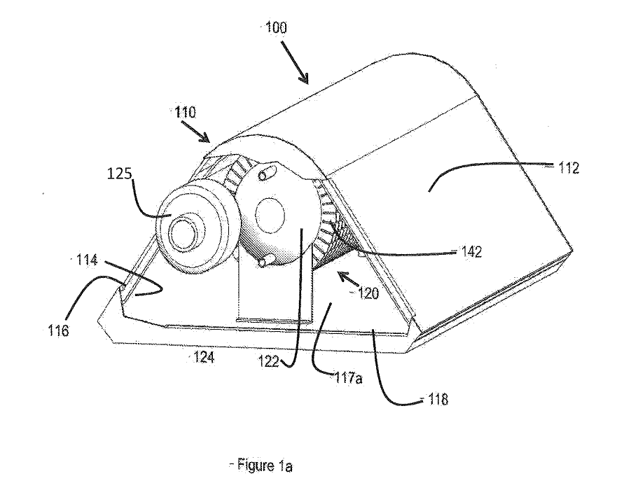

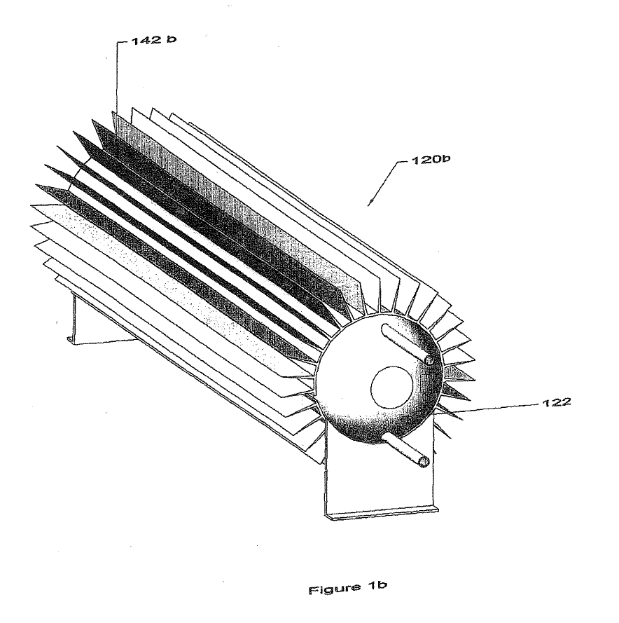

FIG. 1 schematically depicts water heating system embodiment 100. The system includes housing 110, and a water tank 120 situated therein. In between the housing 110 and the water tank 120 there is a space 130 which is typically filled with air 132. Although the examples in the disclosure aimed at water heating systems, any other fluid can be heated in such systems.

The housing 110 is preferably sealed against entrance and exit of air such that loss of energy in the form of air 132 molecule's kinetic energy is restricted. The sealing may not be hermetic, as a hermetic sealing may not be cost effective, particularly when a loose seal still provides a user sufficiently hot water.

In this embodiment the housing 110 includes a platform 118 and external, internal main walls 112, 114 respectively, and front wall 117a and hack wall (not shown), that together essentially define the housing 110.

Both main walls 112, 114 are essentially transparent to light, preferably to visible and IR wavelength light; in some embodiments also to UV light. Most of the external main wall 112 is separated from the internal main wall 114 by an essentially transparent gap 116 which preferably is configured to help reduce loss of energy from the space 130 to the environment outside the housing 110. For example, the gap 116 is in sub pressure, i.e. air is sparse and thus minimal heat is lost by transfer of heat from the internal main wall 112 to the external main wall 114 via air in the gap 116.

The water tank 120 stands on the platform 118 with legs 124. The legs 124 and the platform 118 are sufficiently sturdy to hold the weight of the tank full of water. In some embodiments the platform comprises heat-insulating and/or reflective material to help prevent loss of heat from the water tank and walls 112, 114 to outside the housing 110.

In other embodiments the platform is coloured dark e.g. black on a side facing the water tank.

The water tank 120 comprises a simple watertight container 122, having an essentially smooth exterior devoid of ridges or other protrusions (thereby easily manufactured), and fins 142 thereon that improve the water-heating efficiency of the water.

The external wall is in some embodiments a double wall itself (also known as multiwall), for example SUN LIGHT® of Palram. The external wall may he made of a transparent polycarbonate sheet for example, and is preferably 6-10 mm thick. The internal wall is typically made of similar materials, e.g. transparent polycarbonate also, hut is typically much thinner, e.g. 0.6-0.7 mm. The front wall 117a and the back wall 117b are made for example from a TRIPPLE wall of polycarbonate, preferably somewhat thicker than the internal and external main walls 112, 114. For example, in some embodiments the front wall 117a and the hack wall 117b are 32 mm thick (each sheet).

In some embodiments the external wall and/or internal wall is made of glass. However, we have found that surprisingly superior results are obtained with embodiments in which the walls are made of polycarbonate, the tank water in such embodiments does heat up to a temperature as high as 90° C.

The platform 118 is made for example of an insulation panel containing polyurethane foam 50-100 mm thick sandwiched between sheets capable of supporting the water tank stand, such as tin sheets.

In some embodiments the housing further comprises light-reflective layers that are positioned to allow reflecting some of the light that enters the housing but does not shine on the water heater or

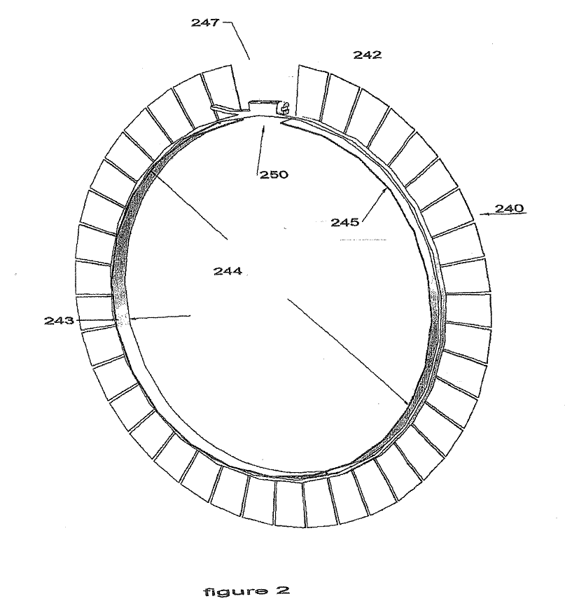

FIG. 2 illustrates a circlet 240 with fins 242 having good light absorbance and thermal transfer coefficient, similar to the fins 142 shown in FIG. 1. The fins 242 can be coupled to a water container such as the water container 120 shown in FIG. 1. The fins 242 are disposed on a circlet 240. The circlet 240 has a hand 245 having a width 243 that allows the circlet to be flexible. In addition, the circlet 240 has an opening 247. The band 240 has an internal diameter 244 that matches the external diameter (not shown) of the water container in the system. The opening 247 is sufficiently wide to allow snapping the circlet 240 onto the water container, as shown in FIG. 1. The band 245 abuts the water container and holds the circlet 240 in place there.

The width 243 of the band 245 is preferably between 0.5 and 1 mm. The circlet 240 is made of one or more parts and/or materials; preferably the latter are heat-conductive. For example, the circlet is made of brass or copper.

One great advantage of the snap-on circlets 240 is that the container is a simple cylinder, and since the housing essentially isolates the container from the environment, the container excludes thermal insulation as it is not required. Moreover, thermal insulation would interfere with transfer of heat from the fins, from light striking the container (thus heating the exterior of the container) and from direct heat on the container (e.g., from hot air striking the container), and thus thermal insulation in or on the container is actually counterproductive. The container may he made of composite materials, and should be strong enough to bear its own weight plus the weight of the water held therein (notwithstanding the support of the legs). The interior (not shown) of the container is made, or is at least lined with, non-corrodible and non-leaching material such as polypropylene.

Each band 245 can he tightened onto the water tank by a screw clamp 250. In other embodiments the circlets are simply snapped onto the water tank. In yet other embodiments the circlets are welded to the tank.

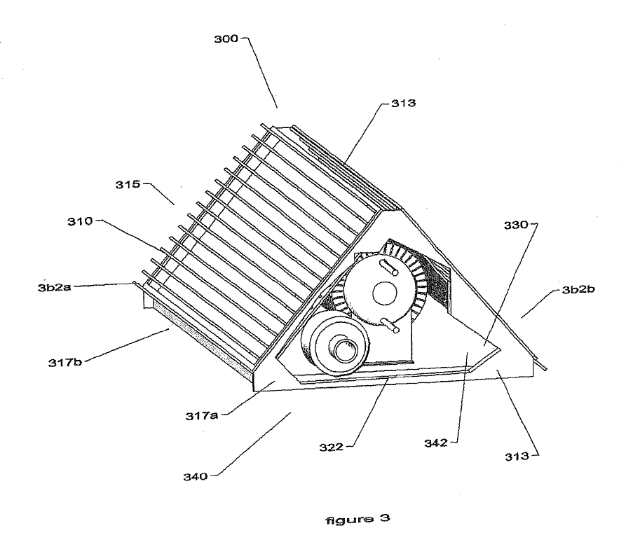

Another system embodiment 300 is shown in FIG. 3. In this system 300 there are multiple circlets 340 laid all along the water container 322. In addition to the contiguous walls (as in the system 100 shown in FIG. 1, but here removed for the sake of clarity), the housing 310 further comprises sets 312a, 312b of shutters 313.

The shutters 313 on the left set 312a are open, thus allowing sunlight to shine on the air in the space 330 and on the container 322 and fins 342. The shutters 313 on the right set 312b are closed, as the sun is shining from the left. The right set 312b is closed since there is less input of energy from the right side and closing the set helps reduce heat loss from the system. In some embodiments the shutters 313 comprise light reflective material on their interior side 315 (the side facing the container 322 when the shutter 313 is closed). The main walls under the shutters 313 can be made of a thermoplastic material such as polycarbonate, or glass, since the shutters 313 may also serve to protect the main walls from damage.

The opening and closing of the shutters is preferably automatically regulated by a system (not shown) comprising at least two motors, at least one for each set of shutters, and light sensitive sensors, for example sensors sensitive to light intensity, and control circuitry configured to allow adjusting the shutters according to the measurements by the sensors. The control may be simple, i.e. between an open and shut state, or may be staged or continuous, i.e. the degree the shutters are open is according to the light intensity and the direction of the light. The control circuitry may comprise a thermostat immersed in the water in the container, to allow adjusting the water temperature to a maximal or set value, so the shutters are opened to the degree that produces the desired heating results.

The front wall 317a and the back wall (not shown) are both solid. Preferably they are both hermetically sealed so that when the shutters 313 are all closed the housing 310 is essentially sealed from the external environment. The front wall 317a and the back wall 317b are also thermally insulating.

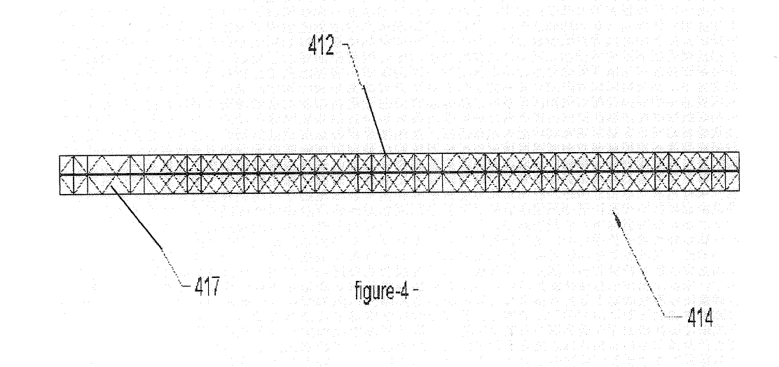

FIG. 4 shows a single gridded wall made of an external sheet 412 and an internal sheet 414 interconnected with a supportive grid 417. The grid 417 is optically transparent plus lends strength to the housing. The total thickness of the grid plus external sheet 412 and internal sheet 414 is for example 32 mm. The gridded wall may he made of an acrylic or carbonate polymer.

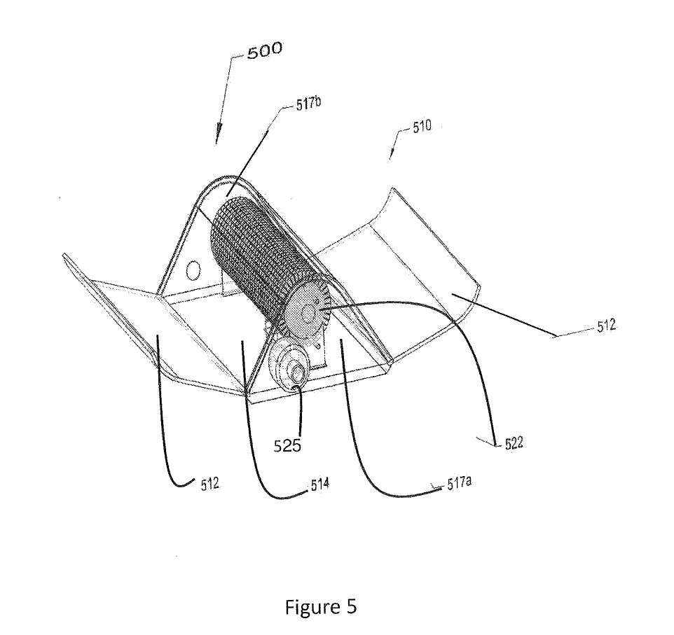

FIG. 5 illustrates another embodiment 500 in which there are external walls 512 that are essentially flaps. When there is sufficient light to heat the water in the container 522 the walls 512 are open, and at other times the walls close 512, thereby forming an external wall very similar to the wall 114 in the system depicted in FIG. 1. Again, the wall-flaps 512 are preferably automatically controlled; they may partially open according to the lighting conditions, optionally the opening is also conditional upon the temperature outside the housing 510. A control system (not shown) may include the temperature and light intensity sensors connected to a computer or similar control circuit, and the circuit in turn connected to a motor operating the wall-flaps 512, according to the programming of the circuit with the sensors input as parameters.

The wall-flaps 512 in some embodiments comprise insulating material such as polyurethane foam and again in some embodiments their interior sides comprise light reflective material to improve collection of solar energy by the tank 522.

Again, the front wall 517a and back wall 517b are typically somewhat thick, e.g. 25-32 mm, and the internal wall 514 is thinner, e.g. 6 to 12 mm thick. These walls may be made of polyurethane foam, which is opaque but has high thermal insulation properties.

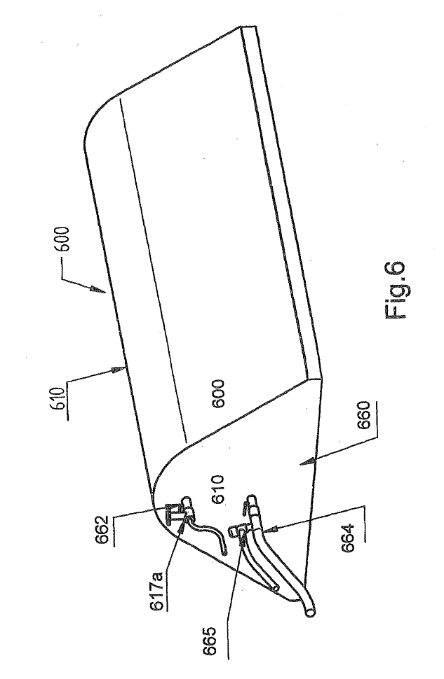

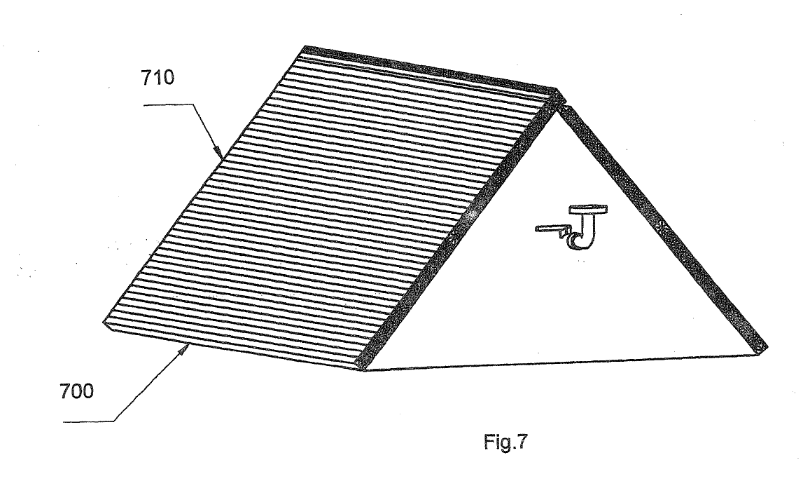

The housing preferably has a non-flat shape, to allow good exposure of the housing to sunlight, better than attainable by flat housings. As shown in FIGS. 6 and 7, some in embodiments 600 the housing 610 is hemispherical; in other embodiments 700 the housing 710 is pyramidal.

The hemispherical housing 610 is slightly harder to construct than the pyramidal one 710, but usually conforms better to the shape of the water tank (not shown) and may be aesthetically more pleasing. Piping 660 penetrates the front wall 617a and extends from the water tank (not shown) to outside the housing 610. The piping connects the water tank to the user's building: cold water is sent to the water tank via cold water pipe 664 and hot water is supplied to the user via hot water pipe 662. A check valve mechanism 665 is connected to the cold water pipe 664 to prevent water from escaping through the cold-water pipe 664. As in commercially available water heating systems, in some embodiments there is also provided a pressure release valve to prevent overpressure in the feed of water to the tank.

The pyramidal housing 710 is typically somewhat higher than the hemispherical housing 610, but the pyramidal housing is typically merely a meter or so high and is thus not very conspicuous. Both pyramidal housings and hemispherical housings may comprise said flaps to increase solar energy input and efficiency, by having heat-insulating layers and/or light reflective layers.

Referring to FIG. 7, it is notable that the water tank is not visible. However, despite the apparent opaqueness of the housing, the water heating is very good.

One advantage of the present invention over the common water heating systems, having solar collectors with piping and separate water tanks, is that the length of the housing is not limited beyond limitations such as installation space; whereas in the common systems the water collector needs to have an elevated end to allow circulation of water within the collector (the circulation itself reducing the efficiency of the system), thus limited by height considerations (safety etc), as well as the increase of required pressure in the water piping of the collectors, as the length increases. The water tank in the present invention may be positioned at a slight incline to facilitate accumulation of relatively hot water at the top of the water tank, close to the hot water pipe exit.

Another advantage is that the orientation of the system relative to the sun is less important than in the commercial solar collectors, thus a more uniform and overall better heating may be provided by the invention.

Wall flaps may be added and used with the pyramidal housings just as they are used with the hemispherical housings.

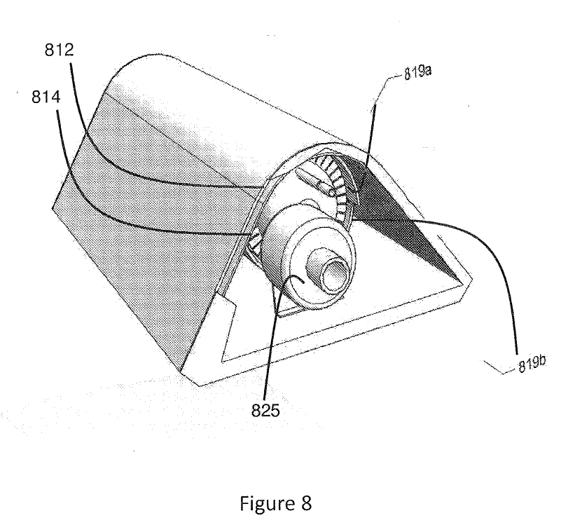

Another embodiment 800 is illustrated in FIG. 8. The system 800 has a housing 810 with an external double wall 812 and an internal double wall 814 each 6-10 mm thick. A hood 819a is positioned over the water tank 822. The hood 819a is essentially positioned between the tank 822 and the housing 810, i.e. the internal double wall 814, and is further positioned such that when the housing 810 is exposed to sunlight the hood 819a is rolled under the tank 822, however the hood 819a is rotated up again around the water tank 822 when the housing 810 is not exposed to sunlight or the exposure diminishes below a predetermined threshold. An undercover 819b matching in shape to the hood 819a is positioned under the tank 822. The undercover 819h is sized such that when the hood 819a is rotated, the hood closely slides over or under the undercover 819b (leaving a small gap between them). The undercover 819b is typically also rotatable around the water tank 822. The hood and undercover are preferably also thermal insulators and in some embodiments comprise layers of light reflective material that can help capture some of the light that enters the housing but does not directly impinge upon the water tank. In some other embodiments there is no undercover.

For days when a large amount of hot water is needed, or there is little sunlight, or extra heating is required to prevent the water in the system from freezing, the system further provides in some embodiments a hot water electric heater. One such heater 870 is schematically shown in FIG. 8.

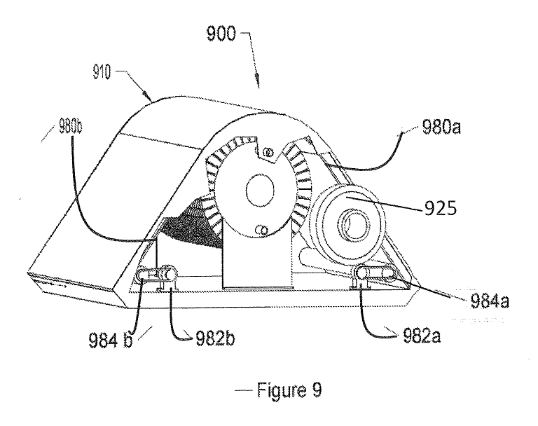

Another system 900 is depicted in the cutout view in FIG. 9. The system comprises heat isolating blankets 980a and 980b wound around rollers 984a and 984b respectively.

The blankets 980a, 980b are wound up and unwound on the rollers 984a, 984b by motors 982a, 982b respectively, according to the measured intensity of the sunlight on the housing 910.

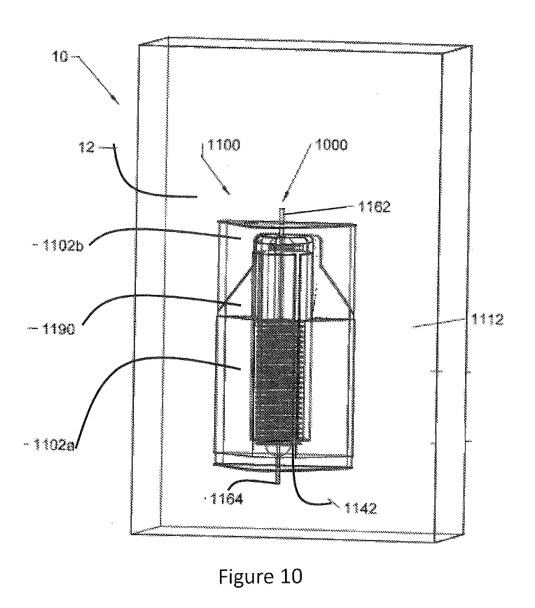

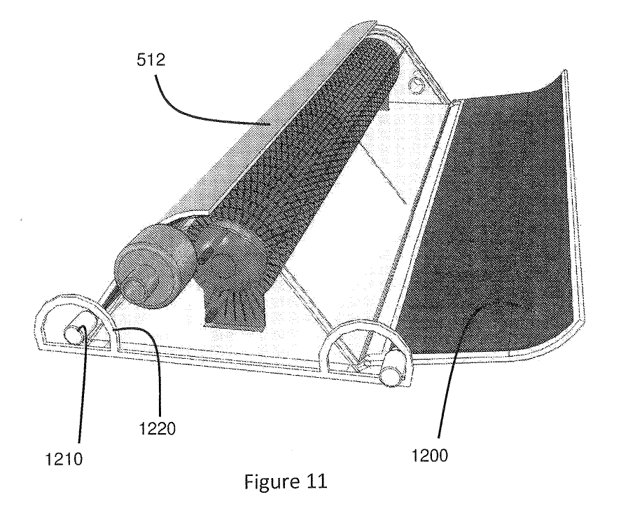

The housings may be installed at various locations, such as on a flat roof, in a back yard or an empty lot, or may even be installed onto and/or into a vertical wall 12 of a building 10 as shown in FIG. 10. The system 1000 has a housing 1100 that includes a bottom part 1102a with a cold-water pipe 1664 The bottom part 1102a is configured to allow enhanced absorption of solar radiation and conversion thereof to thermal energy, similar to the embodiments described above. In addition, the housing includes an upper part 1102b with a hot-water pipe 1162. The top part 1102b comprises thick thermal insulation 1190 since hot water is concentrated in this part. The bottom part 1102a serves to heat the cold water and is thus equipped with fins 1142 and has transparent external wall 1112 and internal wall (not shown), and the top part 1102b serves to retain the heat of the water heated in the bottom part 1102a, and does not necessarily comprise fins or transparent walls.

The water tank should to be securely anchored in its vertical orientation (as shown) to the building, preferably bolted to thick concrete or steel beams and/or bollards in or behind the wall, with the bolts being secured to the beams with threaded plates, and/or by other suitable securing means. The entire tank or housing, or only part thereof, may be installed in the vertical wall, for example a prefabricated opening may he planned and implemented during the construction of the wall, that conforms to the size and shape of the tank or housing.

In any of the embodiments described above the housing may comprise a single transparent wall that is preferably heat-isolating.

The orientation of the housing is optimized in regard of exposure to sun, generally this orientation is south east—to north west, although the preference may be different according to the global location of the installation, room constraints and surrounding foliage, buildings and/or mountains. It should be realized that the non-flat structures of the housing provide better overall exposure to solar radiation compared to the exposure of flat solar collectors, as flat solar collectors are limited in efficacy to a much more constricted range of angles relative to the sun. For embodiments installed on vertical walls the wall is generally the most southern one (in the northern hemisphere).

Some embodiments further comprise means to transfer heated air from inside the housing to outside the housing, for example to heat a building or a portion therein. See for example the bellows 125, 325, 525, 825 and 925 in FIGS. 1a, 3, 5, 8 and 9 respectively. Typically at least one fan is coupled to a conduit extending from inside the housing, for example through a front or back wall of the housing, to the building, and there is an air entry that may allow fresh air into the housing to replace the vented hot air. The conduit and the entry can be controlled (automatically or by manual application, directly or remotely) to be opened to allow fresh air into the housing and vent hot air, or closed to hermetically seal the housing to prevent loss of heat. Control of the fan and the conduit and the entry may he automatically set according to the temperature of the heated water (measured for example by a thermometer coupled to the hot water exit pipe), time of day, daily consumption of the hot water, combinations thereof etc.

According to another aspect a system capable of producing usable heat that is most or even the entire energy consumption requirement of a household, even in cold locations, is provided. The system may be structured similar to the systems described in FIGS. 5 and 9, and is shown in FIG. 11. The flaps 512 may comprise at least one solar collector 1200 on the side facing the water tank. Such systems may have at least one motor 1210 coupled to at least one flap, by means of a gear 1220 for example, to control opening and closing of the flaps as is required, and as explained above. The solar collectors are in some embodiments, water heating and in other embodiments they are photoelectric and convert the energy in the light to electricity. Yet other embodiments combine water heating and photoelectric collectors.

Other embodiments further comprise wheels on which the housing and/or tank rests, to allow transporting the system from place to place according to need.

The solar collectors may be planar, as the commonly available collectors are, in which case the housing is likely to he pyramidal. However, non-planar collectors are also known; therefore, some embodiments comprise a hemispherical housing and conforming collectors.

Such a system having a tank and housing about 8 meters long and 1 meter wide may provide a power of about 44 kilowatts*hour per day, for example 33 kilowatts*hour in the form of hot water and air power, and 11 kilowatts*hour as electrical power. Thus the roughly 1 cubic meter tank may be heated 30-65° above the surrounding temperature. In the western world the average power consumption per capita is about 37-45 kilowatts*hour per day (mostly water heating, and air heating) and thus the system may meet or exceed the daily energy needs of an individual.

Some embodiments (not shown) further comprise batteries to help store the produced electrical energy.

20

1. A heating system comprising:
a non-flat transparent housing comprising walls made of heat isolating material;
a tank within the housing for receiving liquid;
a platform laid on the ground;
legs holding the tank on the platform;
light-absorbent and heat conductive fins coupled to the tank;
a cold fluid inlet with a non-return valve therein, and a hot water fluid, the inlet and outlet extending from the tank to outside the housing; and
means to transfer heated air from inside the housing to outside the housing.

2. A heating system comprising:
a non-flat transparent housing comprising a top part and a bottom part, wherein the bottom part comprises a first layer of heat isolating material and the top part comprises a second layer of heat isolating material, wherein the second layer is substantially thicker than the first layer;
a tank within the housing for receiving liquid;
means to secure the tank in a vertical orientation to a building;
light-absorbent and heat conductive fins coupled to the tank;
a cold fluid inlet with a non-return valve therein, and a hot fluid outlet, the inlet and outlet extending from the tank to outside the housing; and
means to transfer heated air from inside the housing to outside the housing.

3. The heating system of claim 1, further comprising a fan directed to blow on the fins.

4. The heating system of claim 1, further comprising circles that comprise the fins and wherein the circlets are snap-ons.

5. The heating system of claim 4, wherein the circlets each further comprise a band 0.5-1 mm thick that abuts the tank.

6. The heating system of claim 1, further comprising a hood adjacent to the tank and essentially positioned between the tank and the housing, and rotatable around the tank, the hood configured to allow the tank to be exposed to sunlight, when the housing is exposed to sunlight having an intensity above a predetermined threshold, by rolling around the tank to below the tank, and to help the tank retain heat, when the housing is exposed to sunlight having an intensity below a predetermined threshold, by rolling around the tank to above the tank and wherein the system further comprising an undercover adjacent to the tank and essentially positioned between the tank and the platform, wherein the undercover comprises heat-isolating material and the hood is closely slidable over or under the undercover.

7. The heating system of claim 2, further comprising a fan directed to blow on the fins.

8. The heating system of claim 2, further comprising circles that comprise the fins and wherein the circlets are snap-ons.

9. The heating system of claim 8, wherein the circlets each further comprise a band 0.5-1 mm thick that abuts the tank.

10. The heating system of claim 2, further comprising a hood adjacent to the tank and essentially positioned between the tank and the housing, and rotatable around the tank, the hood configured to allow the tank to be exposed to sunlight, when the housing is exposed to sunlight having an intensity above a predetermined threshold, by rolling around the tank to below the tank, and to help the tank retain heat when, when the housing is exposed to sunlight having an intensity below a predetermined threshold, by rolling around the tank to above the tank and wherein the system further comprising an undercover adjacent to the tank and essentially positioned between the tank and the platform, wherein the undercover comprises heat-isolating material and the hood is closely slidable over or under the undercover.
